(19) United States
(12) Patent Application Publication
(10) Pub. No.: US 2011/0089134 A1
(43) Pub. Date: Apr. 21, 2011

(54) METHOD OF COMPRESSION MOLDING A PLASTIC CLOSURE FROM FOAMED POLYMERIC MATERIAL

(76) Inventors: Hugh Morton, (US); Lawrence M. Smeyak, (US); Lindsey Abney, (US); Brandon Hughes, (US); Edward Kresge, Neshanic Station, NJ (US); John Erspamer, (US); Navaneeth Bashyam, (US); Jeffrey M. Pristera, (US)

(21) Appl. No.: 12/869,935

(22) Filed: Aug. 27, 2010

Related U.S. Application Data
(60) Provisional application No. 61/237,752, filed on Aug. 28, 2009.

(51) Int. Cl. B65D 41/00; B29C 44/40

(52) U.S. Cl. 215/353; 264/51

(57) ABSTRACT

A method of compression molding a plastic article, such as a closure, includes providing a molten polymeric material, comprising a mixture of at least one molten polymer and a gas blended therein. The polymeric material is molded between cooperating male and female molds, with relative movement of the molds controlled to form a mold cavity with a predetermined volume. Formation in this manner acts to produce a molded closure with substantially reduced density, thus achieving desired material savings, while still providing a closure or like article exhibiting desired performance characteristics.

### TECHNICAL FIELD

The present invention generally relates to compression molding of articles from polymeric material, such as plastic closures and the like, and more particularly to a method for compression molding an article such as a plastic closure from foamed polymeric material, to thereby desirably achieve weight and cost savings, while providing the molded closure with the desired structural and related performance characteristics.

### BACKGROUND OF THE INVENTION

Molded plastic closures, such as for use on containers having carbonated and non-carbonated beverages, as well as other food and non-food products, have met with widespread acceptance in the marketplace. Compression molding of such plastic closures has proven to be particularly cost-effective, permitting closures which exhibit the necessary structural and sealing characteristic to be economically formed at high speed, thus permitting their cost-effective use on a wide variety of beverages and other products.

The use of foamed polymeric materials, such as for formation of injection-molded articles, is well-known in prior art. By the creation of a two-phase polymeric material, including a cellular structure formed from the polymeric material and gas cells, desirable material savings can be effected, while still providing articles which exhibit the requisite structural characteristics. Technologies for creating such foamed polymeric articles include introduction of chemical foaming or “blowing” agents into the polymer melt stream, as well as the injection of gas into the polymer melt. In typical processes, expansion of the gas within the polymeric material is controlled by controlling the pressure of the polymeric material as it is delivered to an associated mold. Chemical forming agents can also be employed as processing aids for injection molding of articles, such as to fill in and smooth sink marks and like imperfections.

Typical rotary compression molding tooling technology entails delivery of a metered charge of polymeric or plastic melt material to an open mold. The mold is then closed, and a male core pin is forced into the mold space, thereby displacing the measured plastic charge into the desired product shape. This is sometimes referred to as a “force driven” system. The “hydraulic” reaction force created by the plastic material as it is formed and cooled eventually balances the force used to drive the core pin, and stops the penetration of the core pin into the mold space. Thus, the forming pressure applied to the core pin, is typically on the order of 2,000 p.s.i., is entirely delivered to the plastic charge during the initial forming of the part.

This rotary compression mold tooling action works well for molding closures out of non-foamed polymeric materials, and has been used very successfully to commercially produce such products. However, when the identical technology is used to form closures from pre-foamed plastic melt charges, which are non-Newtonian or non-isotropic, and can be highly compressible, the result is that the initial application of the entire core pin forming load affects the retention of gas bubbles in the molded article, and significantly limits the ability to obtain the desired closure density reduction. In effect, the molding forces exceed the load-bearing capability of certain portions of the article being molded, acting to “quench” and limit the expansion of the foamed polymer.

In rotary compression molding using foamed materials, a pre-foamed plastic charge is delivered to an open cavity at atmospheric pressure, and remains in this condition for a short period of time before the mold is closed, and the action of the core pin forms the charge into the shape of the desired final product. During this time of exposure to atmospheric pressure (typically called “residence time”), the gas blended in the polymer is already forming bubbles and expanding the measured plastic melt charge. Thus, when the forming pin applies all its initial forming load to the pre-foamed plastic charge, the magnitude of the load delivered directly to the polymer is large enough to limit the retention of gas bubbles in the molded article, and effectively quench any further foaming action, even when the mold space is quickly and accurately expanded through a predetermined tooling motion. The present invention is directed to a method of compression molding a plastic article that results in significant product density reductions when using pre-foamed measured plastic melt charges.

As noted, it is desired to use a foamed polymeric material to substantially reduce the weight of plastic closure products via a significant reduction in material density. This desirably results in substantial material cost savings for manufacture of articles from polymeric material. In an environmental context, where desired goals include “re-use”, “recycle”, and “reduce”, the present invention desirably acts to “reduce”, that is effect “source reduction” by the use of less material for initially forming the desired closure products.

Another aspect of the present invention concerns obtaining the desired foamable molten polymeric material. In the process of foaming polymeric materials for use in rotary compression molding, it is highly desirable to maintain sufficient pressure to keep the gas in solution within the extruded polymer melt stream up to the point that the melt exits the compression molder nozzle. Once the melt stream exits the nozzle, it is cut into individual foamed pellets, and the individual foamed pellets are delivered to the mold cavities for formation via compression molding into the final closure products. Maintaining sufficient gas pressure can be most easily accomplished by reducing the orifice size/area in the compression molder nozzle. Reduced orifice size/area will provide enough flow resistance to increase the melt pressure upstream of the nozzle to levels sufficient to keep the majority of gas in solution.

Unfortunately, simply reducing the orifice size/area substantially changes the physical size and aspect ratio of the cut foamed pellet. Orifice sizes/areas small enough to maintain sufficient gas pressure result in pellet sizes and aspect ratios that are virtually impossible to fit within the available space of the mold cavities. Thus, simply reducing nozzle orifice size/area to maintain sufficient gas pressure does not present a viable manufacturing method for processing polymeric foamed materials in a typical rotary compression molding process.

Theoretically, delaying the expansion of foamed polymeric material in an extruder system until the last possible moment creates a large pressure drop which results in the nucleation of more gas bubbles. Creating a smaller orifice in the nozzle through which flow is restricted acts to increase the pressure in the delivery system to pressures sufficient to keep the majority of gas in solution. The limitation of this method is dependent upon pellet dimensions. If the nozzle orifice diameter is reduced too much, then the length of the pellet becomes longer than the diameter of the cavity. At this point, it becomes impossible to keep the pellet in the cavity and therefore, impossible to mold the pellet in accordance with conventional molding techniques.

### SUMMARY OF THE INVENTION

In accordance with the present invention, a method of compression molding of plastic closure or like article from foamed polymeric material addresses problems associated with rotary compression molding of such foamed material. In one aspect of the present invention, enhanced foaming of the polymeric material is achieved by controlling the size of the mold cavity within which each article is formed. In another aspect of the invention, the flow of the molten polymeric material is restricted, prior to introduction into the mold cavity, to thereby maintain a sufficient gas pressure within the molten polymeric material. This flow restricting step can be achieved through the use of a plurality of flow-restricting orifices, or through the use of an adjustable, flow-restricting valve assembly.

Thus, the present invention contemplates a “displacement driven” molding system, wherein a rotary compression mold is provided with a quantity of pre-foamed molten polymeric material, with the mold thereafter closed to define a mold cavity having a predetermined volume in order to permit gas within the molten material to foam and expand the material to provide a finished closure having the desired dimensional and structural characteristics. In distinction from conventional compression molding of articles, wherein non-foamed molten polymeric material is subjected to relatively high pressure during molding to “pack” a mold cavity, the present invention contemplates that molten polymeric material is placed in a mold cavity having a predetermined volume, with foaming of the polymeric material providing the closure with the desired morphology.

In accordance with the present invention, a method of compression molding of plastic closure comprises the steps of providing molten polymeric material, including a mixture of at least one polymer and a gas therein. The method further includes providing a mold assembly including a female mold, and a cooperating male mold pin which fits generally within the female mold to define a mold cavity of the mold assembly.

The present method further includes depositing a predetermined quantity of the foamed polymeric material, at atmospheric pressure, in the female mold. Thereafter, the mold assembly is closed by relatively moving the female mold, and the male mold pin, to compress the polymeric material. Notably, during closing of the mold assembly, relative movement of the female mold and the male mold pin is controlled in order to form the mold cavity with a predetermined volume, thereafter permitting the expansion of the polymeric material under the influence of the gas blended therein to form the plastic closure. The relative movement of the female mold and male mold pin are controlled in that the relative velocity and acceleration between the male mold pin and the female mold are controlled to approximately a zero level at a final controlled and predetermined penetration of the male mold pin into the female mold.

Thereafter, the mold is optionally partially opened to permit expansion of the polymeric material under the influence of the gas to form the plastic closure. Opening of the mold assembly permits the plastic closure to be removed there from, and the cycle repeated.

In another aspect of the present invention, the polymeric material is recompressed after partially opening the mold assembly, to thereby form the plastic closure.

Thus, the present invention contemplates a two-phase molding system, including formation of articles from the blend of polymeric material and a gas, which can be provided by a mixture of at least one polymer, and one or more compounds capable of producing a gas, which typically may comprise carbon dioxide and/or water vapor. An important aspect of the present invention is controlling the closing motion of the mold assembly in order to effect closing of the mold without destroying the cellular structure of the molded closure.

As noted, closing of the mold assembly contemplates controlling the relative movement of the female mold and the male mold pin, including limiting of the closing of the mold assembly by the cooperative action of a cam profile and a spring-biasing force controlling the relative movement of the female mold and the male mold pin. In an alternate form of the invention, the mold assembly is provided with a positive mechanical stop.

As noted, another aspect of the present method contemplates restricting the flow of the molten polymeric material, prior to the step of depositing the material in the female mold, to thereby maintain a sufficient gas pressure within the molten polymeric material. In order to achieve the desired degree of foaming of the material, the present method contemplates partially expanding the molten polymeric material prior to the depositing step.

Restriction of the flow of the polymeric material can be achieved by providing a plurality of flow-restricting orifices through which the molten polymeric material is directed prior to the depositing step. Alternatively, an adjustable flow-restricting valve assembly can be provided through which the molten polymeric material is directed prior to the depositing step.

Other features and advantages of the present invention will become readily apparent from the following detailed description.

### BRIEF DESCRIPTION OF THE DRAWINGS

FIG. 1 is a diagrammatic view of a conventional compression molding system;

FIG. 2 is a diagrammatic view of a compression molding system embodying the principle of the present invention;

FIG. 3 is a CAT-image of a vertical cross-section of a closure formed in accordance with the principle of the present invention;

FIG. 4 is a CAT-image of a horizontal cross-section of a closure formed in accordance with the present invention; and

FIG. 5 is a graph illustrating density reduction of a closure formed in accordance with the present invention.

### DETAILED DESCRIPTION

While the present invention is susceptible of embodiment in various forms, presently preferred embodiments of the invention will be described herein, with the understanding that the present disclosure is to be considered as an exemplification of the invention, and is not intended to limit the invention to the specific embodiments disclosed.

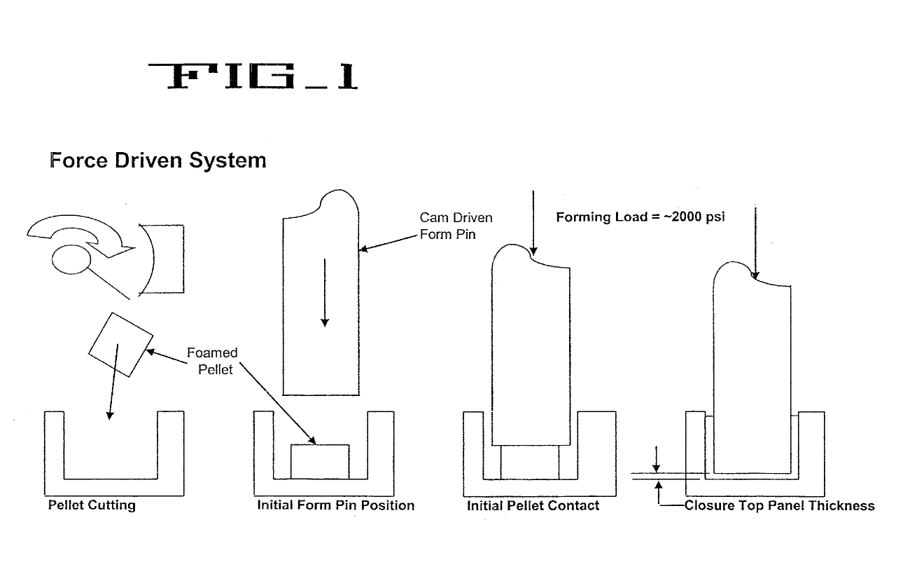

Compression molding of articles such as plastic closures has proven to be very commercially successful, by virtue of the efficiency with which such closures can be precisely formed at high speed. A conventional compression molding apparatus is sometimes referred to as a “force driven system”, the operation of which is diagrammatically illustrated in FIG. 1. In such an arrangement, cooperating male and female mold tooling is provided, with a molten plastic pellet deposited into the open tooling assembly, and the pellet thereafter compression molded to form the desired article.

As illustrated, during the forming process, the male molding assembly, sometimes referred to as the forming pin, is cam-driven downwardly, and displaces the molten pellet into the desired molded closure, or like article. At the point of final filling of the mold cavity, the entire forming load (on the order of about 2,000 psi) is delivered directly to the molten pellet. A downward motion of the forming pin is stopped when the mold cavity completely fills with the polymeric material, and the resultant resistive load developed in the polymer balances the forming load of about 2,000 psi.

In this system, the final top panel or top wall thickness of the closure is controlled by the pellet weight, that is, a heavier pellet produces a thicker top panel, while a lighter pellet produces a thinner top panel.

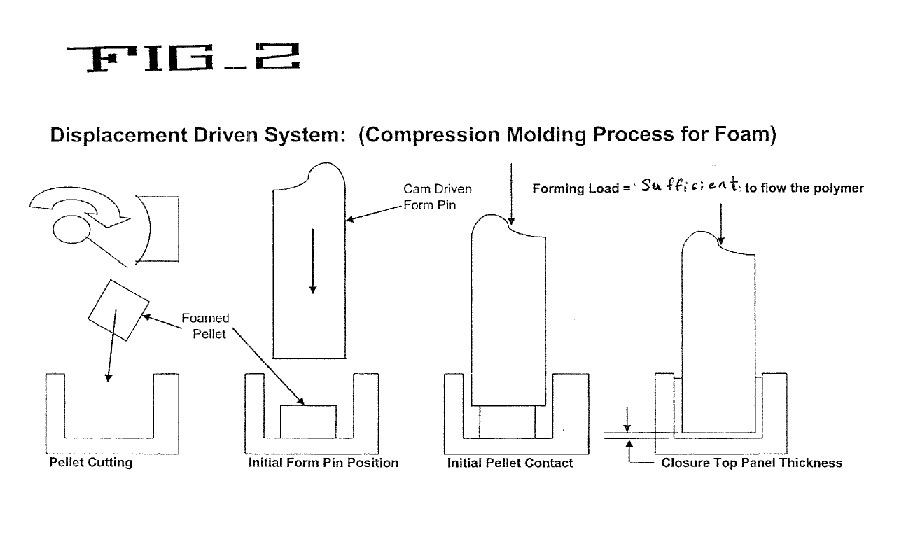

For formation of a foamed closure, or like article, comprising polymeric material and gaseous cells therein, the above-described force driven system is not suitable, since the application of the high forming pressure (on the order of 2,000 psi) acts to drive the gas out of the polymeric material. Thus, for practice of the present invention, a “displacement driven” compression molding system is contemplated, as diagrammatically illustrated in FIG. 2. In such a displacement driven system, the male forming pin is cam-driven downwardly with a cyclodial motion, and displaces the foamed pellet (comprising molten polymer and gas blended therein) into the desired molded closure or like article. Notably, the cyclodial cam motion provides a relatively “gentle” forming process, subjecting the molten material to less forming pressure, in comparison to a conventional compression molding apparatus operating on a force driven system, such as described above.

In accordance with the present invention, the displacement driven system functions such that the downward motion of the forming pin is stopped when the forming pin reaches a predetermined position determined by the design of the associated cam. In this system, the final top panel thickness of the closure is independent of the pellet weight, and is totally controlled by the predetermined final elevation of the forming pin. As a consequence, any pellet weight variation will be exhibited as density variability, not top panel thickness variability as in the standard compression molding process.

The load applied to the molten polymer is primarily determined by the viscosity of the foamed polymer, and will be substantially less than the typical 2,000 psi supplied during the conventional compression molding process. Formation in this manner is particularly effective for formation of a foamed closure, since the forming loads applied to the polymer are substantially less than those in a standard compression molding process, and the gas blended into the molded polymer is not forced out of the polymer.

For rotary compression molding using pre-formed plastic melt charges, the present invention contemplates that instead of using the “hydraulic” reaction force of the pre-foamed plastic melt charge to stop the penetrating motion of the core pin into the mold space, a tooling and/or associated cam design is employed in which the initial penetrating motion of the core pin into the mold space is limited by controlling and limiting the closing movement of the mold assembly, before the entire forming load is delivered to the pre-foamed plastic melt charge, which can otherwise limit the retention of gas bubbles in the molded article, and effectively quench further foaming action. The invention contemplates use of opposing spring actions (or electromagnetic/pneumatic/hydraulic actuations) in the tool to balance and stop the penetrating motion of the core pin, and/or by providing a motion-limiting cam used to drive the core pin into the mold space. It is also contemplated that the penetrating motion of the core pin into the mold space can be stopped by the use of a positive mechanical stop.

The basic inventive principle is to stop the penetrating action of the core pin into the mold space before a threshold pressure is reached in the polymer that results in limiting the retention of gas bubbles in the molded article and effectively quenching further foaming action.

Optionally, after the penetrating motion for the core pin is stopped, a secondary tooling motion can be provided that quickly and accurately expands the mold space, causing a significant pressure drop to allow the continually emerging gas in the polymer melt charge to continue to expand, and fill the “new” mold space, thus producing products with significant density reductions.

In accordance with a further aspect of the present invention, it is envisioned that one or more additional cycles of tooling motion can occur after the core pin motion is initially stopped, and the mold space is quickly and accurately expanded. In this aspect of the invention, the initial motion that expands the mold space can be used to create a mold space expansion larger than that intended in the final molded product. This provides more space and time for foam to be generated. A subsequent tooling motion (or motions) can then used to recompress the semi-molten foamed material to the final desired product geometry.

In order to restrict the flow of molten polymeric material prior to the step of introducing predetermined quantities of the material to each female mold, it is desired to maintain sufficient gas pressure in the molten polymeric material prior to the material leaving the rotary compression molding nozzle, while at the same time producing a foamed pellet size and shape that can be successfully cut and delivered to the rotary compression molding cavities. Gas blended within the molten polymeric material can be injected into the molten polymer, prior to the cutting and formation of pellets for depositing in the compression mold female mold cavities, or can be provided by one or more gas-producing foaming or “blowing” agents blended with the polymer.

In one aspect of the invention, a suitable orifice restriction, sized to provide enough flow resistance to assure sufficient pressure upstream of the restriction, is placed in the melt stream at the inlet of the rotary compression molder nozzle block. The nozzle block geometry downstream of the restriction is then profiled to allow the foamed melt to expand, before actually exiting the nozzle, so that an appropriate foamed pellet geometry capable of easily fitting into the molded cavity envelop can be generated.

Alternatively, an adjustable valve can be placed in the melt stream at the inlet of the rotary compression molder nozzle block. The nozzle block geometry downstream of the valve is then profiled to allow the foamed melt to expand before actually exiting the nozzle, so that an appropriate pellet geometry capable of easily fitting into the molder cavity envelop can be generated. The valve orifice can be adjusted manually to maintain sufficient pressure, or the valve orifice can be automatically controlled through a closed loop feedback system employing a pressure transducer placed in the melt stream just upstream of the valve location.

By this method, an appropriate sized foamed pellet can be delivered to the rotary compression molder cavities, while maintaining sufficient gas pressure up to the point of pellet cutting and delivery.

In a further aspect of the present invention, a multi-orifice nozzle uses a reduced hydraulic radius to create the required pressure drop through the nozzle, rather than a pressure drop due to a small aperture. An advantage of this design is the ability to force a pressure drop similar to a small nozzle, while at the same time having a cross-sectional flow of a large nozzle. This permits the system upstream of the nozzle to maintain the desired sufficient pressure, while still providing a pellet that will fit within the associated mold cavity.

As will be appreciated, it is desirable to provide a substantially uniform and homogeneous mixture of the base polymeric material and the gas blended therein. To this extent, it can be desirable to dispersively or distributively mix the foamed polymeric material prior to depositing a quantity of the material in the associated compression molding apparatus. This can be achieved by providing a fixed element, said as static mixer, in the foamed polymer stream to mix the polymeric material. Alternative elements or devices may be employed for enhancing the mixing and uniformity of the foamed polymer before it is deposited in the associated mold.

Plastic closures, and like articles, formed in accordance with the present invention can desirably achieve cost savings by reduction in the use of the polymeric material from which they are formed, with contemplated weight reductions on the order of 10-20%. Reduction in the quantity of polymer used in such articles can result in very significant cost savings, since the cost of the polymeric material typically represents at least half of the cost of the article itself. This can be particularly advantageous with the use of relatively costly bio-resins such as polylactic acid and polyhydroxy alkanoates, and polyolefins prepared from partially or fully renewable feed stocks such as ethanol, as opposed to typical petroleum based polymers. Additionally, as will be appreciated, moldable polymeric materials that can be employed for practice of the present invention may comprise constituents, in addition to the base polymer resin, such as pigments, lubricants, fillers, etc., as are known in the art.

Desired material savings, as well as desired closure performance, can be achieved by forming an article which is foamed substantially throughout the article. It is desired to achieve the requisite closure performance, at low swept density, while providing a closure which exhibits the necessary resistance to doming, provides the desired sealing performance, resists cracking, and exhibits the necessary impact strength.

Rheological parameters influence material selection in connection with foamed polymeric closure articles. While polyethylene can be easily foamed, polypropylene polymer can be more difficult to foam. Extensional viscosity, that is, the capability of being expanded to a balloon-like structure, is a factor in material selection.

Because the expansion of gas from within the polymer melt tends to be an endothermic reaction, expansion of the gas acts to cool the article during molding. This is desirable since cooling of the articles can be effected more efficiently, in addition to the typical liquid-cooling of the mold assembly which is typically provided. Notably, this endothermic reaction can assist with cooling of the thick portions of a molded article, and may desirably result in less cooling demand for the overall method.

Colorant selection must also be considered, since colorants typically result in shrinkage of the polymer during cooling, after polymer crystallization. Such colorants can also affect foaming action, with certain colorants enhancing the formation of small cells or bubbles.

Practice of the present invention permits formation of plastic closures having a novel combination of features. In particular, the present invention contemplates formation of closures having at the least two portions which are foamed, that is, having a cellular structure, wherein the portions of the closure exhibit different average densities. More particularly, attendant to formation by compression molding, closures are formed having a top wall portion, and an annular skirt portion depending from the top wall portion. Notably, both the top wall portion and the skirt portion are formed from foamed polymeric material, with both the top wall and skirt portions having regions of substantially lower densities that the non-foamed base material.

Generally speaking, foaming capability within the closure is related to localized pressures within the mold cavity during closure formation, since loads on the polymeric material during closure formation can limit foam formation.

As noted above, closures formed in accordance with the present invention provide environmental benefits in the form of “source reduction”, that is, by limiting the quantity of polymeric material introduced into the environment. Such “source reduction” is further achieved by limiting the dimensional characteristics of the closure, in particular, the closure height. To this end, a package embodying the principles of the present invention can desirably be provided by use of a plastic closure exhibiting foamed portions having differing average densities, with such a closure used in combination with a container having a so-called “short height” bottle finish, the threaded portion of a container. One such bottle finish is commonly referred to as a PCO 1881, and when used in combination with a closure embodying the principles of the present invention, further provides the desired environmental benefits of “source reduction”, while at the same time providing desired costs savings.

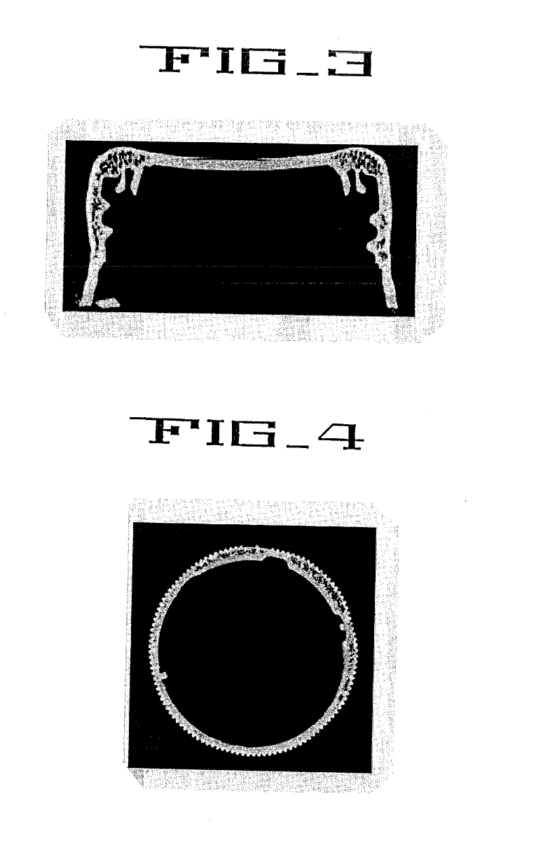

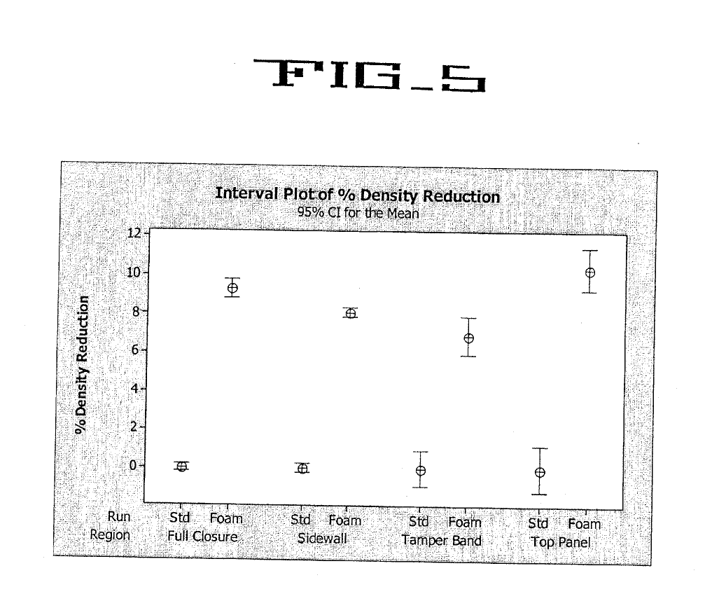

FIGS. 3 and 4 are CAT (computed axial tomography) images of a molded plastic closure formed in accordance with the present invention. Notably, the foamed nature of the closure is readily apparent, with the cellular nature of the closure structure plainly evident at the top panel or top wall portion of the closure, as well as in the depending annular skirt portion and associated helical thread formation. FIG. 4, a CAT image taken horizontally through the thread formation of the closure, plainly shows the foamed, cellular nature of the closure side wall and thread formation.

FIG. 5 graphically illustrates the density reduction of a plastic closure formed in accordance with the present invention in comparison to a non-foamed plastic closure formed by a conventional compression molding process.

The accompanying Table 1 identifies characteristics of sample closures formed in accordance with the present invention. The following table is supporting evidence for Claim 1:

| Sample | | | | | Density |
|---|---|---|---|---|---|
| # | Form | Base Resin | Foaming Agent | Color | (g/cc) |
| 1 | Closure | Exxon 9092 | 0.4% wt. loading @ | None | 0.777 |
| | | | 2:2.4 Citric Acid: | | |
| | | | Sodium Bicarbonate | | |
| 2 | Pellet | Exxon 9092 | 0.4% wt. loading @ | None | 0.583 |
| | | | 2:2.4 Citric Acid: | | |
| | | | Sodium Bicarbonate | | |
| 3 | Closure | Exxon 1572 | None | Yellow | 0.908 |
| 4 | Pellet | Exxon 1572 | None | None | 0.891 |

From the foregoing, numerous modifications and variations can be effected without departing from the true spirit and scope of the novel concept of the present invention. It is to be understood that no limitations with respect to the specific embodiments disclosed herein is intended or should be inferred. The disclosure is intended to cover, by the appended claims, all such modification as fall within the scope of the claims.

1. A method of compression molding a plastic article, comprising the steps of:
providing molten polymeric material, including a mixture of at least one molten polymer and a gas blended therein;
providing a mold assembly including a female mold, and a cooperating male mold pin which fits generally within said female mold to a define a mold cavity of said mold assembly;
depositing a predetermined quantity of said polymeric material, at atmospheric pressure, in said female mold;
closing said mold assembly by relatively moving said female mold and said male mold pin to compress said polymeric material, including controlling the relative movement of said female mold and said male mold pin forming said mold cavity to a predetermined volume thus producing a molded article with substantially reduced density; and
opening said mold assembly, and removing the molded plastic closure therefrom.

2. A method of molding an article in accordance with claim 1, wherein
said gas is provided in said mixture by the provision of a gas-producing compound blended with said polymer.

3. A method of molding an article in accordance with claim 1, wherein
during said closing step, the relative velocity and acceleration between the male mold pin and the female mold are controlled to approximately a zero level at a final controlled and predetermined penetration of the male mold pin into the female mold.

4. A method of molding an article in accordance with claim 3, including prior to said opening step, partially opening said mold assembly to permit expansion of the polymeric material under the influence of the gas to form said plastic closure.

5. A method of molding an article in accordance with claim 4, including recompressing said polymeric material after partially opening said mold assembly to form said plastic closure.

6. A method of molding an article in accordance with claim 1, including providing said mold assembly a positive mechanical stop for limiting closing of said mold assembly.

7. A method of molding an article in accordance with claim 1, including limiting closing of said mold assembly by the cooperative action of a cam profile and a spring-biasing, pneumatic, hydraulic, or electromagnetic actuation force controlling the relative movement of said female mold and said male mold pin.

8. A method of molding an article in accordance with claim 1, including restricting the flow of the molten polymeric material prior to said depositing step, to thereby maintain a sufficient gas pressure within said molten polymeric material.

9. A method of molding an article in accordance with claim 8, including partially expanding said molten polymeric material prior to said depositing step.

10. A method of molding an article in accordance with claim 8, including providing a plurality of flow-restricting orifices through which said molten polymeric material is directed prior to said depositing step.

11. A method of molding an article in accordance with claim 8, including providing an adjustable flow-restricting valve assembly through which said molten polymeric material is directed prior to said depositing step.

12. A method of molding an article in accordance with claim 1, including
prior to said depositing step, dispersively or distributively mixing said molten polymeric material to increase uniformity of said material.

13. A method in accordance with claim 12, including
providing a static mixer to dispersively or distributively mix said molten polymeric material.

14. A plastic closure, comprising:
a top wall portion; and
an annular skirt portion depending integrally from said top wall portion,
said top wall portion and said skirt portion further comprising a first layer having a density substantially the same as the density of a non-foamed base material and a second relatively less dense foamed layer that is formed in situ; each of said top wall portion and said skirt portion being formed from foamed polymeric material and each having regions of lower density than the non-foamed base material.

15. A plastic closure in accordance with claim 14, wherein said non-foamed base material comprises partially or fully renewable feedstock.

16. A package, comprising;
a plastic closure configured in accordance with claim 14; and a container having a neck finish for receiving said closure.
